(19) United States
(12) Patent Application Publication
(10) Pub. No.: US 2021/0086968 A1
(43) Pub. Date: Mar. 25, 2021

(54) SMART CANNIBIS APPARATUS

(71) Applicant: GO ON GREEN, LTD., TEL AVIV (IL)

(72) Inventor: IDO HAVILIO, TEL AVIV (IL)

(21) Appl. No.: 16/576,139

(22) Filed: Sep. 19, 2019

(51) Int. Cl. B65D 51/24; B65D 43/02; A47J 42/40; G06Q 30/06; G06F 16/951; G10L 15/22; G01G 19/40; H04L 29/08; H04W 4/80

(52) U.S. Cl. CPC B65D 51/24; B65D 43/02; A47J 42/40; G06Q 30/0631; G06F 16/951; G10L 2015/223; G01G 19/40; H04L 67/12; H04W 4/80; B65D 2215/00; G10L 15/22

(57) ABSTRACT

A smart cannabis apparatus including a smart cannabis apparatus including, a main body attached to a base. The apparatus further includes a controller for handling input and output data, data processing and data computing. The apparatus further includes a container having an opening, the container is housed in the main body and stores one or more types of cannabis strains. A container splitter to partition said container to at least two separate chambers. The apparatus further includes a lid to open or close the container opening. The apparatus further includes a humidity control element for ensuring pre-determined relative humidity (RH) level for an optimal humidity conditions for the cannabis strains in the two or more chambers. The apparatus further includes a communication unit to wirelessly communicate with one or more remote communication devices. The one or more remote communication devices comprising at least one dedicated application for receiving data from the apparatus and viewing real time information about the environmental climate conditions in said at least two chambers and about the user cannabis strains consumption, preferences and personal user effects.

### FIELD OF THE INVENTION

The present invention relates to medical cannabis, in particular to a smart cannabis apparatus for storing and monitoring cannabis freshness and usage.

### BACKGROUND OF THE INVENTION

Cannabis strains are either pure or hybrid varieties of the plant genus Cannabis, which typically encompasses the species C. sativa, C. indica, and C. ruderalis. In recent years, many hybrid sub-species of Cannabis were created. Cannabis strains commonly refer to those varieties with recreational and medicinal use. Medical cannabis users usually receive two varieties of cannabis for consumption. One cannabis strain is typically for the day use and the second cannabis strain is for the night use.

Typically each strain of marijuana/cannabis has varying amount of tetrahydrocannabinol (THC) and Cannabidiol (CBD) materials. Each of the materials has different effects on the user and the mere combination of the different cannabis strains creates another variable and set of results. Although there is a vast existing information and research about each of the aforementioned strains, there is no sufficient database on the benefits and side effects of the growing number of hybrid species and sub-species and on the consumption of different combinations of said strains. The number of possible strain combinations along with different user characteristics makes it hard to monitor the different individually experienced effects of each strain and combination thereof on different users.

Therefore, it is desirable to create a comprehensive database of information on medical cannabis consumption and side effects information collected from actual users using crowdsourcing in lieu of information collected solely from laboratory researches. One of the benefits of the present invention is to provide a comprehensive database on the medical and side effect influences of cannabis consumption based on the exact strain that is being consumed, and about the existing side effects and influences of combining different cannabis strains, each with different varying amounts and ratios of consumption during several years on many medical cannabis users.

Yet another benefit of the present invention is that a medical cannabis user can actively and passively feed information to a database about his medical cannabis usage or his different strain cannabis combination and consumption amount and other information about his personal cannabis related habits, use and side effects. By creating such a database which will include many medical cannabis users from all around the world, third parties such as but not limited to researches, cannabis companies, non-profit organizations and more, will be able to connect to the database to derive beneficial insights and benefits from the database information for example to improve the lives of cannabis users.

Yet another benefit of the present invention is to enable each user to accurately follow his or her private consumption habits. Not only at the cannabis weight and amount of consumption but also the consumption of exact materials, suc as, for example, THC and the CBD which can takes into account that, for example and without limitation, one strain of cannabis may have 20% THC and 30% CBD and a second strain of cannabis may have 45% THC and 15% CBD.

Yet another benefit of the present invention is to provide a cannabis machine that senses when the medical cannabis stock of a user is running out. The cannabis machine will further be able to notify by any suitable communication means the user and a relevant party to place an automatic order to renew his stock in a timely manner when the medical cannabis stock of a user is running out.

Yet another benefit of the present invention is to enable user to maintain their medical habit consumption, goals and preferences more accurately.

Yet another benefit of the present invention is to provide a medical cannabis apparatus that will allow medical cannabis consumers efficient solution for tracking consumptions and effects for treatment.

Yet another benefit of the present invention is to provide a medical cannabis apparatus that will provide medical cannabis consumers an efficient way to track and detect certain consumption combinations from which to avoid or to act upon based on specific user past experiences and or said database.

Yet another benefit of the present invention is to provide a system that will allow industry cannabis/marijuana professionals to access an accurate, consistent, and comprehensive statistical insight into consumption preferences and habits.

Yet another benefit of the present invention is to provide a medical cannabis apparatus that will be able to electronically communicate with additional existing devices, such as, for example, alarm clocks, smart watches, and the like, in order to provide a holistic understanding to industry leaders and researchers about habits, consumption side effects and more useful crowdsource insights about cannabis consumption.

### SUMMARY OF THE INVENTION

The present invention relates to medical cannabis, in particular to a smart cannabis apparatus for storing and monitoring cannabis freshness and usage.

In accordance with an embodiment of the present invention there is provided a smart cannabis apparatus including, a main body attached to a base. The apparatus further includes a controller for handling input and output data, data processing and data computing. The apparatus further includes a container having an opening, the container is housed in the main body and stores one or more types of cannabis strains. A container splitter to partition said container to at least two separate chambers. The apparatus further includes a lid to open or close the container opening. The apparatus further includes a humidity control element for ensuring pre-determined relative humidity (RH) level for an optimal humidity conditions for the cannabis strains in the two or more chambers. The apparatus further includes a communication unit to wirelessly communicate with one or more remote communication devices. The one or more remote communication devices comprising at least one dedicated application for receiving data from the apparatus and viewing real time information about the environmental climate conditions in said at least two chambers and about the user cannabis strains consumption, preferences and personal user effects.

### BRIEF DESCRIPTION OF THE DRAWINGS

The invention may be understood upon reading of the following detailed description of non-limiting exemplary embodiments thereof, with reference to the following drawings, in which:

FIG. 1 is a perspective front view illustrating a smart cannabis apparatus in accordance with some embodiments of the present invention;

FIG. 2 is a perspective exploded view of smart cannabis apparatus shown in FIG. 1;

FIG. 3 is a schematic block diagram of the smart cannabis apparatus interacting with a remote communication device and with cloud storage and computing through a wireless communication network; and

FIG. 4 is a block diagram illustrating schematically an exemplary graphic user interface application pages in accordance with some embodiments of the present invention installed for example on a remote device.

### DETAILED DESCRIPTION OF EMBODIMENTS OF THE INVENTION

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

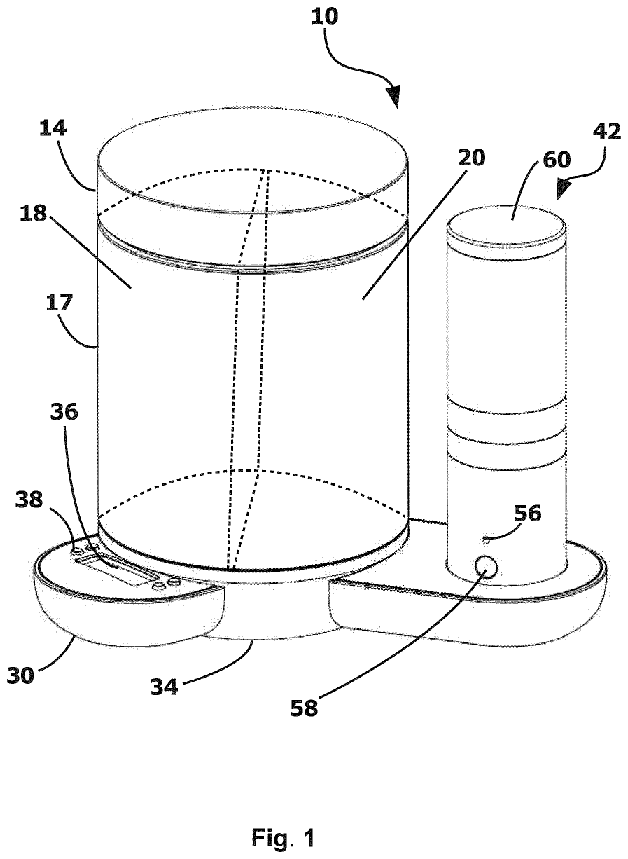

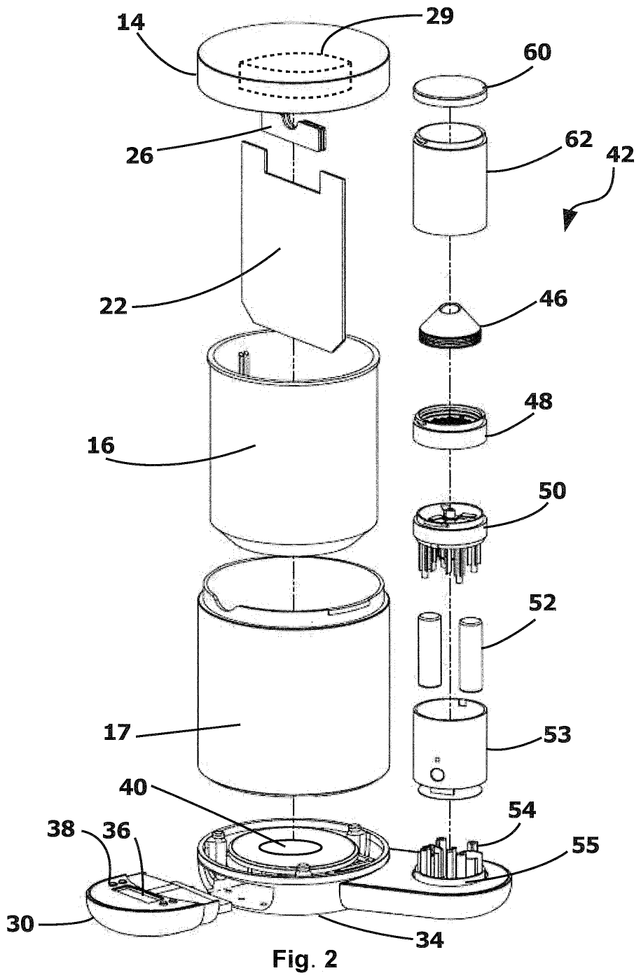

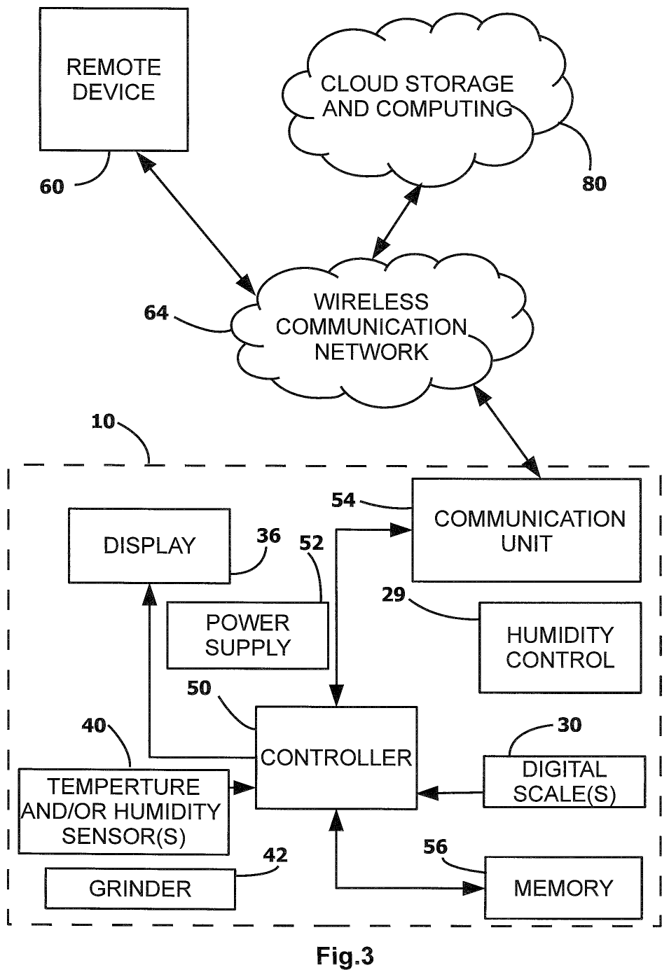

Referring first to FIG. 1 and FIG. 2, there is shown a smart cannabis apparatus 10 in accordance with some embodiments of the present invention. The smart cannabis apparatus 10 includes a lid 14, preferably, a child proof lid having a suitable locking means preventing children from opening the lid 14 of a container 16. The container 16 is housed in a main body 17. In some embodiments of the present invention the smart cannabis apparatus 10 can send an automated alert to a remote communication device 60 (shown in FIG. 3), when the lid 14 is opened. The remote device 60 can be any suitable communication device such as but not limited to Smart phones, personal computers, servers and tablets. The container 16 preferably is partitioned to two separate dual storage chambers 18 and 20 which are split by a container splitter 22. Each of the chambers 18 and 20 keeps cannabis strains separately. The splitter 22 divides enclosure of the container 16 to the two chambers 18 and 20. In some embodiments of the present invention the container splitter 22 can be removable. In another embodiment of the present invention the container splitter 22 can split the container enclosure to any separate desired number of chambers. Preferably, day and night time cannabis strains are stored separately inside the two chambers 18 and 20. To the container splitter 22 can be attached a labeling housing 26 which can be made of transparent material such as but not limited to glass or plastic inside the labeling housing the user can insert a labeling information about the strain type inside each of the chambers 18 and 20.

The apparatus further includes a humidity control means 29 such as but not limited to the commercial two-way Boveda™ humidity control for ensuring pre-determined relative humidity (RH) level for an optimal humidity conditions for the cannabis strains in the chambers 18 and 20. More detailed information about Boveda™ humidity control element can be found for example in U.S. Pat. Nos. 9,750,811, 8,748,723 and 6,921,026. The apparatus further includes at least one, but not limited to, smart digital scale 30 for separately weighting each strain quantity in each of the chambers 18 and 20 accurately. The smart digital scale is preferably attached to a base 34 of the apparatus 10. The base 34 is attached to the bottom portion of main body 17. The smart scale may have in some embodiments of the present invention an Internet of Things (IoT) connectivity for example to a dedicated mobile/PC app or to a database/application server/cloud. The smart digital scale may have a digital display 36 such as but not limited to an Organic Light-Emitting Diode (OLED) display or a Liquid Cristal Display (LCD). The smart digital scale may further include control buttons 38. In some embodiments of the present invention the display 36 is also a touch screen. The apparatus 10 may further include one or more temperature and/or humidity sensors 40 for individualized monitoring of optimal storage temperature and humidity in each of the chambers 18 and 20. The apparatus further includes an electric marijuana/cannabis grinder 42 which is detachably connected to the apparatus base 34. The grinder 42 can be manually removed from the base 34 when it is used. Preferably, the grinder 42 stores up to four grahams, dedicated kief collector, protects and collects trichomes to insure minimal damage to the collected trichomes. The marijuana/cannabis grinder can be a hand held marijuana/cannabis grinder as known in the art which includes a grinder funnel 46, a grinder filter 48, grinder knives 50, batteries 52, grinder body 53, batteries house 54, grinder base 55 a light indicator, 56 a power button 58, a grinder lid 60 and a grinder container 62.

Referring also to FIG. 3, the smart cannabis apparatus 10 further includes a controller 50 for data processing, computing and handling input and output data for example, the data received from the temperature/humidity 40 sensors and the data received from the digital scale 30. The display 36 is electrically connected to controller 100. The display 106 can display information such as but not limited to the cannabis weight and quantities that are stored in the chambers 18 and 20. Device 10 further includes a power supply 52 for powering the electronic components in the apparatus 10. In some embodiments of the present invention apparatus 10 may also include a communication unit 54 which can communicate with one or more remote digital devices 60 such as but not limited to a Smart phones, PCs, tablets, web servers, and the like. The remote device 60 may include one or more applications which can receive and/or send information from/to apparatus 10 through communication unit 54. Remote device 60 may include a database and one or more algorithms to analyze the readings from the user personal input, from the digital scale 30 sensors 40 and to provide on the remote device useful information for example about the user cannabis/tobacco consumption habits and experiences based on the information received from apparatus 10 through communication unit 54. Apparatus 10 further includes an internal memory 56 for storing data such as but not limited to the, user cannabis/tobacco consumption habits, experiences and preferences and the history reading of the sensors data and digital scale data. Communication unit 54 may include WIFI, Bluetooth or any other suitable communication methods known in the art for wirelessly communicating between communication unit 54 and remote device 60 for example through a wireless communication network 64 such as but not limited to the Internet and the cellular network. In some embodiments of the present invention apparatus 10 one or more parts of the apparatus 10 can be disassembled by the user for cleaning and replacement purposes.

In accordance with the present invention the user may further be provided with a dedicated application that can be downloaded to his remote device 60. The application can provide the following parameters: real time information from the smart apparatus 10 about the strains quantities in the chambers 18 and 20, the chambers humidity and temperature such that a user can keeps an accurate track all of the aforementioned parameters. The application may further provide direct purchase platform to purchase or order actively or passively, medical cannabis strains from dispensers. The application may further provide personalize preferences for example, share and rate strains, combination of strains and experiences thereof, set personalized treatment goals and set notifications. The application may further provide automatic dosage tracking by total consumption of specific strains or aggregated consumption of a specific substance, such as, for example, THC, CBD or others. For example, track consumption by quantity, time, strain, cannabinoid levels and record effects in real time. The apparatus can also automatically deliver current usage information date time and history using the log consumer to better track their cannabis consumption routine and improve its effects. The user can rate the strain he receives, the use, and effects and receive same type of information from other users and get their recommendations. The application can scan unique ID (UID) to automatically populate cultivar information. Once the smart apparatus 10 identifies cannabis shortage, details nearby dispensers offering a prescribed website is provided to the user on his remote device display.

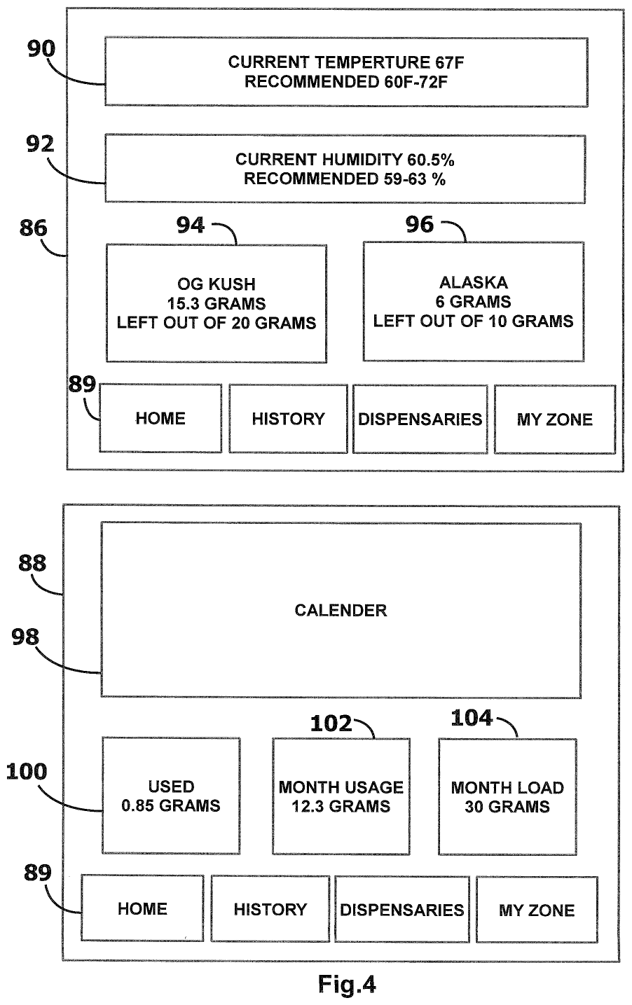

Referring also to FIG. 4 there is shown schematically exemplary graphic user interface application pages 86 and 88. Each page may include action virtual buttons 89 of “HOME”, “HISTORY”, “DISPENSARIES” and “MY ZONE” each of the buttons when pressed directs to the receptive “HOME”, “HISTORY”, “DISPENSARIES” and “MY ZONE” pages. In the “HOME” page 86, the user can view the current temperature and humidity in the chambers 18 and 20. Furthermore, the user can view the recommended optimal conditions in the chambers 18 and 20. In the example page 86, in a label window 90 the user sees that the current temperature is 67° Fahrenheit and the recommended temperature is between 60° Fahrenheit and 72° Fahrenheit. In the example page 86, in a label window 92 the user sees that the current humidity is 60.5% and the recommended humidity is between 59% and 63%. In the example page 86 the user can also follow the current quantity by strain in each of the chambers 18 and 20. For example, in label window 94 the user sees that in chamber 18 there is cannabis strain “OG KUSH” with a quantity of 15.3 grams left out of 20 grams. In label window 96 the user sees that in chamber 20 there is cannabis strain “ALASKE” with a quantity of 6 grams left out of 10 grams.

In the “HISTORY” page 88 the user can watch his usage history by month, week or day. The user may also see a daily drill-down by time and strain. The user can also download and view graph and statistics about for example, his history dosage consumption and preferences. The user can also share his dosage history with other users or to cloud storage and computing 80. In the example page 86, a label calendar window 98, label window 100 shows for example how that the user used 0.85 grams of cannabis in a certain day. In label window 102 the user month usage is 12.3 grams. In label window 104 the month cannabis load is 30 grams.

In the “DISPENSARIES” page, not shown, the user gets information of dispensers carrying the user preferred strains. The user can search in the application for nearby dispensers. In this page for example, the user receives deals and offers from the user favorite dispensaries. The user can also easily purchase via a “buy now” or “refill prescribed stock” button. In some embodiments of the present invention when apparatus 10 senses the medical cannabis stock of a user is running out. The cannabis machine will further be able to notify by any suitable communication means the user and a relevant dispensary to place an automatic order to renew his stock in a timely manner when the medical cannabis stock of a user is running out. The automatic order notification and the cannabis stock running out notification can be shown for example automatically in the “DISPENSARIES” page.

In the “MY ZONE” page, not shown, the user can set automatic notifications. The user can be notified automatically when its time to re-order cannabis. The user can receive personal recommendations by the user desired cannabis effects. The user can rate the strains he consumes and write reviews which are then can be shared with other users and can be downloaded to the cloud storage and computing 80. In this page the user can also, share information anonymously about pricing, his cannabis strains' effects and more.

In some embodiments of the present invention the smart apparatus can be voice activated for example and without limitation with voice assistance applications: Alexa, Google Home and Siri.

In some embodiments of the present invention in the cloud storage and computing 80 provided a comprehensive database for obtaining medical cannabis and side effects information of actual users and not just information collected from laboratory researches. For example, comprehensive database on the medical and side effects influences of combining different cannabis strains with different amounts and ratios during several years on many medical cannabis users. The raw data for this comprehensive database can be collected from many users who use the apparatus 10 and the related application installed on the user remote communication device. In another embodiment of the present invention industry cannabis/marijuana professionals can access cloud storage and computing 80 for accurate, consistent, and comprehensive statistical insight into cannabis consumptions, preferences, habits, effects and side effects of many users and during several years.

In another embodiment of the present invention the smart medical cannabis apparatus 10 and/or the cloud storage and computing 80 and/or the remote device 60 receives data from wearable internet of things (IoT) devices and/or from their related database servers. The wearable internet of things (IoT) devices are for example but not limited to smart watches and smart wristbands. the user's data that comes from the wearable internet of things (IoT) devices and their related database servers are sent to the cannabis apparatus and/or to the cloud storage and computing and/or to the remote device in order to establish a sufficient information that will help finding the user's specific medical cannabis strain type(s) and cannabis dosage(s) that best fit him for improving his life quality.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A smart cannabis apparatus comprising:
a main body attached to a base;
a controller for handling input and output data, data processing and data computing ;
a container having an opening, said container housed in said main body and stores one or more types of cannabis strains;
a container splitter to partition said container to at least two separate chambers;
a lid for opening and closing said container opening;
at least one humidity control element for ensuring pre-determined relative humidity (RH) level for an optimal humidity conditions for the cannabis strains in said at least two chambers; and
a communication unit to wirelessly communicate with at least one remote communication device;
wherein, said at least one remote communication device comprising at least one dedicated application for receiving data and viewing real time information from said apparatus about the environmental climate conditions in said at least two chambers and about the user cannabis strains consumption, preferences and personal user effects.

2. A smart cannabis apparatus according to claim 1, wherein said apparatus further comprises an electric cannabis grinder which is detachably connected to said apparatus.

3. A smart cannabis apparatus according to claim 1, wherein said lid is a child proof lid having a suitable locking means preventing children from open said lid; said apparatus sends an automated alert to said communication remote device when said proof lid is opened.

4. A smart cannabis apparatus according to claim 1, wherein said apparatus further comprising at least one smart digital scale for separately weighting each strain quantity in each of said chambers accurately.

5. A smart cannabis apparatus according to claim 1, wherein said smart cannabis apparatus further comprising at least one temperature sensor for individualized monitoring of optimal storage temperature in each of said at least two chambers.

6. A smart cannabis apparatus according to claim 1, wherein said humidity control means is a two-way Boveda™ humidity control element(s).

7. A smart cannabis apparatus according to claim 1, wherein said at least one application provides personalized preferences sharing and enables users to rate strains, set personalized treatment goals and set notifications.

8. A smart cannabis apparatus according to claim 1, wherein said at least one application provides automatic dosage tracking, track consumption by quantity, time, strain, cannabinoid levels and record cannabis usage effects on a user in real time.

9. A smart cannabis apparatus according to claim 1, wherein said apparatus automatically delivers said at least one remote communication device and said cloud storage and computing the current cannabis usage information date time and history using the log consumer to better track their cannabis consumption routine and improve its effects.

10. A smart cannabis apparatus according to claim 1, wherein said apparatus can scan Unique ID (UID) to automatically populate cultivar information; once said smart apparatus identifies cannabis shortage, details nearby dispensers offering a prescribed website is provided automatically to the user on his remote communication device.

11. A smart cannabis apparatus according to claim 1, wherein each chamber contains different type of cannabis strain.

12. A smart cannabis apparatus according to claim 1, wherein said remote communication device and said apparatus enables a direct purchase platform over a communication network to purchase medical cannabis strains from dispensers.

13. A smart cannabis apparatus according to claim 1, wherein said apparatus is voice activated with voice assistance application.

14. A smart cannabis apparatus according to claim 1, wherein said application collects from said apparatus the user's cannabis THC and CBD consumption.

15. A system for collecting and analyzing cannabis user preferences and consumptions comprising:
a smart cannabis apparatus having at least two chambers for separately storing at least one type of cannabis strain; said apparatus collect in real time the quantity, humidity and temperature data in each chamber;
at least one cloud storage and computing; and
at least one remote communication device comprising a dedicated application for collecting cannabis quantity, humidity and temperature data in each chamber and providing a user the current and the history log of said cannabis quantity, humidity and temperature data;
wherein, said at least one cloud storage and computing provided a comprehensive database collected from at least one remote communication device and from said smart cannabis apparatus for obtaining medical cannabis and side effects information of actual users about their medical and side effects influences of combining different cannabis strains with different amounts and ratios during several years on many medical cannabis users.

16. A system according to claim 15, wherein said user uses said application to rate the strain he receives the use and effects from other users and get their recommendations.

17. A system according to claim 15, wherein industry cannabis/marijuana professionals can access said at least one cloud storage and computing for accurate, consistent, and comprehensive statistical insight into consumption preferences and habits of many users.

18. A system according to claim 15, wherein said smart cannabis apparatus further comprising an electric cannabis grinder which is detachably connected to said apparatus.

19. A system according to claim 15, wherein said smart medical cannabis apparatus and/or said cloud storage and computing and/or said remote communication device receives data from wearable Internet of Things (IoT) devices and/or from their related database servers; the user's data that comes from said wearable Internet of Things (IoT) devices and their related database servers are sent to said cannabis apparatus and/or to said cloud storage and computing and/or to said remote device in order to establish a sufficient information that are utilized to find the user's specific medical cannabis strain type(s) and cannabis dosage(s) that best fit said user for improving said user life quality.
